(19) United States
(12) Patent Application Publication
(10) Pub. No.: US 2014/0284431 A1
(43) Pub. Date: Sep. 25, 2014

(54) AIRCRAFT STRUCTURE WITH STRUCTURAL NON-FIBER REINFORCING BONDING RESIN LAYER

(71) Applicants: Tommy Grankaell, Borensberg (SE); Per Hallander, Linkoeping (SE); Mikael Petersson, Linkoeping (SE); Bjoern Weidmann, Borensberg (SE)

(72) Inventors: Tommy Grankaell, Borensberg (SE); Per Hallander, Linkoeping (SE); Mikael Petersson, Linkoeping (SE); Bjoern Weidmann, Borensberg (SE)

(73) Assignee: SAAB AB, Linkoeping (SE)

(21) Appl. No.: 14/355,502

(22) PCT Filed: Dec. 12, 2011
(86) PCT No.: PCT/SE2011/051501

§ 371 Date: Apr. 30, 2014

(51) Int. Cl. B64C 1/00

(52) U.S. Cl. CPC B64C 1/00
USPC 244/90 R; 156/307.1; 428/161

(57) ABSTRACT

The present invention regards an aircraft structure comprising an aerodynamic composite shell (7), the interior face (9) of which in whole or in part is bonded with at least one two- or three-dimensional structural composite part (11) by means of a bonding material (15). It also regards a method of manufacture of the aircraft structure. The bonding material (15) comprises a non-structural fiber reinforced resin system, wherein at least one portion of the bonding material, which portion spatially corresponds with an interior face filling volume (21), is thicker than other portions of the bonding material (15), due to settlement of resin of the non-structural fiber reinforced resin system in said interior face filling volume (21) during the viscous phase of the curing of the non-structural fiber reinforced resin system.

### TECHNICAL FIELD

The present invention regards an aircraft structure according to the preamble of claim 1 and a method of manufacture of the aircraft structure according to claim 8.

### BACKGROUND ART

The aircraft structure is defined as a specific structure of an aircraft (or helicopter or other aerial vehicle), such as a wing having a wing shell, a fuselage having a shell (skin), an aileron comprising a shell, etc. The aircraft structure, such as a rudder, may comprise a plurality of stringers fixed to and holding a shell. The shell is regarded as an aerodynamic shell during use, as the air stream flows over the shell when the aircraft is flying. Nevertheless, in this application the word aerodynamic shell also defines a shell (also called aerodynamic) during the manufacture of a shell to be used as a wing shell or other exterior shell of the aerial vehicle or a shell of a not flying aircraft.

The definition “aircraft shell” may also be altered to the wording “aerial vehicle shell”, as the invention as well is applicable to helicopters, missiles etc.

The present design thus relates to an aircraft structure comprising structural composite parts fit and bonded together to form the aircraft structure. The structural composite part can be defined as a three-dimensional structural composite part being used together with at least another specific three-dimensional structural composite part for building the aircraft structure.

Today aircraft composite structures are often made in one cure cycle. There is shown in EP 2 133 263 a method for installation of stringers to an aircraft's skin interior face. In EP 2 133 263 is stated that use of structural adhesives to attach the stringers to the skin results in bonded joints adding weight to the aircraft. EP 2 133 263 solves this problem by placing and compacting the stringers onto the skin for co-curing them with the skin. Forming blocks are used to conform the surface contour of the skin in by sliding and tilting of the block, thus engaging the stringers to the skin.

Another document WO 2010/144009 shows the use of a nano structure applied in a bonding material comprising adhesive resin for providing a strengthened bonding compared with that shown in herein referred document US 2008/0286564. The WO 2010/144009 is filed by the applicant of the present application. The invention shown in WO 2010/144009 has proper functionality, but the present invention now constitutes a development of the aircraft structure and method shown in WO 2010/144009.

It is desirable to provide a method of manufacture of said aircraft structure, which method can be performed fast and with high efficiency.

It is also desirable to provide a method of manufacture of said aircraft structure, wherein the aircraft structure has low weight and still presents high shearing strength within all the joints between the shell interior face and e.g. the stringers.

It is desirable to develop the prior art methods within the technical area.

Furthermore, it is desirable provide an aircraft structure per se manufactured by said method.

### SUMMARY OF THE INVENTION

This has been achieved by the aircraft structure defined in the introduction being characterized by the features of the characterizing part.

The definition of “non-structural fiber reinforced resin system” means in this application a structural resin system comprising non-structural fibers. That is, the resin system (or third uncured resin substrate) comprises no structural fibers. The resin of the resin system per se is structural. The wording of said definition could also be “non-structural fiber resin system” or “resin system not comprising any structural fibers” or “structural resin system not having structural fibers”. The wording “resin system” could also include just “resin” in this application.

Thereby is provided that eventual defects of the interior face and/or of the surface of the structural composite part, such as misalignment between face and surface, voids, cracks or other defects in the interior face of the shell, will be filled with viscous resin of the non-structural fiber reinforced resin system to be cured. This will proceed during one cure cycle, wherein the resins of the shell, the structural parts, and the bonding material will cure at different temperatures, wherein the bonding material resin has a lower curing temperature than the resin of the shell and structural parts. Thus, when the resin of the bonding material has filled the interior face filling area, it will cure and become hard or semi-hard. The shell resin and the composite part resin will still be uncured (during the co-curing with the bonding material in one cure cycle) and still soft/viscous to permit adaption to the curvature of the hardened bonding material. That is, the hard or semi-hard bonding material also serves as a forming tool for the aerodynamic composite shell. It is extremely important that the interior face (and thereby the outer surface of the shell) of the shell will take the predetermined shape and not alter its shape due to eventual defects. This is important, as the flying performance (aircraft fuel consumption etc.) of an aircraft depends upon the aircraft's aerodynamic shell's curvature. It could be the aerodynamic shell of a wing, a fuselage, a fin, a stabilizer, an aileron, a rudder etc. It is also extremely important that the bonding between the shell and the structural parts has high strength. It has been shown by experiments performed by the applicant that even tough reinforcing fibers have not been added to the bonding material resin, the fiber free bonding materiel provides a bonding between the shell's interior face (surface) and the surface of the structural part which has satisfying shearing strength, regarded as high strength (or sufficient) in the aircraft industry. The lack of fibers in the bonding material also saves costly fiber addition. The lack of fibers also promotes that the viscous resin of the bonding material, before it has cured and become hard or semi-hard, i.e. during the viscous phase of the bonding material resin, freely flows into the interior face filling volume. The flowing is performed from portions of the resin situated in areas/volumes of the bonding material resin surrounding the interior face filling volume.

The interior face filling area is defined as an area or volume that corresponds with said defect. The interior face filling volume being defined as the volume (area) having divergent volume (divergent in the meaning of larger volume than the average volume existing per area unit under the shell for contact with the surface of the part) occurring between the interior face and the surface when the shell and structural part do not fit exactly to each other; and following temperature increase provides curing of the third resin before curing of the first and second resin substrates. The settlement of resin of the non-structural fiber reinforced resin system in the interior face filling area proceeds during the viscous phase of the cure cycle of the resin of the bonding material.

Suitably, the non-structural fiber reinforced resin system comprises a carrier of organic fibers. This is provided for keeping the shape of the non-structural fiber reinforced resin system during handling and for maintaining the bonding material's thickness after application and before curing. The organic fibers are not structural and provide no major influence on the free flow of the resin of the bonding material during the viscous phase.

Preferably, the bonding material comprising the non-structural fiber reinforced resin system is a wide spread layer having various thickness, which layer being interleaved between the shell and the structural composite parts' surfaces facing the interior face of the shell. The layer is an integrated part of the aircraft structure and has served as a holding/forming tool during production (co-curing) of the aircraft structure. In such way is produced in one curing step a finished aircraft structure (for example an aileron, a rudder, a wing, a fuselage etc.), which aircraft structure can be made with less reinforcing material (due to the reinforcing effect of elimination of eventual defects of the interior face and/or of the surface of the structural composite parts, such as misalignment between face and surface, voids, cracks or other defects filled with the viscous resin of the non-structural fiber reinforced resin system during the first part of the cure cycle). Less reinforcing material of the aircraft structure means a less weight of the aircraft, which is environment friendly due to less fuel consumption per passenger of the aircraft.

This is achieved by providing the bonding material to serve as a distance material during the curing procedure.

For example, the wide spread layer is distributed over an area below the aircraft structure's shell (between face and surface) within the range of about at least 5000-10000 mm² to about 40-50 m² or larger. In such way is created a wide spread distance holding fly-away tool for providing an exact fit between shell and part and for maintaining the shape of the shell.

Preferably, the non-structural fiber reinforced resin system is a thermo set resin.

In such way is achieved that the viscous phase of the curing cycle of the bonding material resin is highly controllable.

Suitably, the bonding material has an area of distribution extending over two or more bonds joining the interior face and structural composite parts.

In such way the aircraft article will involve high strength at the same time as it can be produced in one cure cycle, which is important for manufacture of series for reaching low production time.

Preferably, the bonding material is considered as a fly-away tool as it is an integrated structure of the aerodynamic shell.

Thereby is an aircraft structure is provided which has a high strength due to close fit between the shell and structural parts (such as ribs, stringers etc) at the same time as the tool, providing the close fit, will form a structure of the shell or structural part, thus saving weight. The forming of said structure will add strength. The saving of weight is due to the fact that you do not have to make the shell thicker for reaching the same strength.

Alternatively, the bonding material propagates parallel with the aerodynamic composite shell.

Suitably, the aircraft structure is an aileron, fuselage, fin, rudder etc.

In such way is achieved that an article of resin composite has been produced for an aircraft in one curing step, at the same time as the strength is high due to close fit (due to the filling out defects and voids performance of the viscous bonding material resin between shell and structural parts) between shell and stringers. The predetermined outer shape of the shell will thus also be maintained due to the fact that the before-hand cured bonding material will act as a holding tool for the forming of the shell. The filling out performance thus promotes the strength of the aileron or other aircraft structure.

This has been achieved by the method defined in the introduction being characterized by the method steps of claim 8.

In such way is achieved that an aircraft structure can be made in one cure cycle, saving time, and simultaneously the aircraft structure will have high strength. The production is controllable in an effective way due the fact that the third resin (bonding material resin) freely flows from areas under the shell, where high pressure prevails, to areas under the shell, where low pressure prevails. This unhindered flowing of the third resin is provided by the lack of fibres within the third resin. This safe and unhindered flow of the third resin makes the production efficient.

Preferably, the bonding material resin is applied onto the shell and/or structural parts (for co-curing in one cure cycle) in such way that the bonding material resin will have an area of distribution, which extends over several bonds joining the interior face and structural composite parts. In such way the aircraft article per se will involve high strength at the same time as it can be made in one cure cycle.

Suitably, the first and second resin substrates formed into the uncured aerodynamic composite shell and an uncured structural composite part comprise so called pre-preg with fiber reinforcement.

Alternatively, the first and second resin substrates, one or both, comprise more than two different resin systems. The first and/or second resin substrate could also just comprise one resin system. Also the third resin substrate could have more than one resin system.

Alternatively, the first and second resin substrates formed into the uncured aerodynamic composite shell and an uncured structural composite part comprise resins that are suitable for liquid composite moulding, wherein the first and second resin substrates are infused into before-hand prepared dry fiber mats and the non-structural fiber reinforced resin system of the bonding material is positioned between the dry fiber mats of the shell and the dry fiber mats of the structural parts. The resin substrates are preferably thermo set.

Preferably, the third resin during the viscous phase is provided for freely flowing towards an interior face filling area having a lower pressure than the other areas surrounding the interior face filling area, wherein settlement of the third resin building up a thicker bonding material which cures before the first and second resin substrates.

In such way a guaranteed distribution of bonding material is achieved in an efficient manner.

Suitably, the bonding material has an area of distribution extending over two or more bonds joining the interior face and structural composite parts.

In such way is it possible to produce in series aircraft structures of low weight and sufficient strength in one cure cycle.

Preferably, the first and second resin substrates are so called B-staged resins.

In such way the uncured aerodynamic composite shell and the uncured structural composite part have enough dimensional stability to be removed from a mould and applied onto the interior face of the shell, but still permit co-curing with the latter and the bonding material.

Co-curing is a promising joining technique in aircraft parts composite manufacturing. The technique is used for integrally curing several parts in one cure cycle. Aircraft industry often uses B-staged material for aerodynamic shells, structural composite parts (stringers, ribs etc.). Positive handability for the B-staged material is due in room temperature. However, the pre-cured resin loses stability when heated for co-curing cycle.

The technique of co-curing is possible if sufficient support is given to the B-staged material in the co-cure cycle. The use of a bonding material in the form of an adhesive film or resin paste or in the form of a B-staged resin material in room temperature gives handability to apply the bonding material resin onto the shell and/or the structural parts for co-curing. It shall be noted that the wording “forming the first and second resin substrate into an uncured aerodynamic composite shell and an uncured structural composite part” also regards the use of B-staged resin material. In some way the B-staged resin material can be regarded as already being cured a little, but just to reach the handability. Nevertheless, the B-staged resin material is regarded as being uncured.

Suitably, the third resin (bonding material resin) has a curing temperature within the range of about 50-150° C., preferably 100-130° C., the first and second resin substrate (shell and structural part resin) have a curing temperature within the range of about 100-200° C., preferably 150-180° C.

In such way benefit is drawn from the gradual heating for curing the bonding material resin before the curing of the shell resin and structural part resin.

Preferably, the third resin has a curing temperature within the range of about 50-80° C., the first and second resin substrate have a curing temperature within the range of about 90-120° C.

In such way the production of series of aircraft structures can be performed with high speed, which is cost-effective.

Suitably, the cure cycle takes place in an autoclave.

Alternative, the cure cycle takes place in an out of autoclave production, such as an oven etc.

Thereby is provided that already mounted production lines can be used for the present invention and the described effective method of producing aircraft structures (ailerons, rudders, fuselage sections, etc.) guaranties free flow of the third resin, whereby a reliable and cost-effective production is achieved.

The word composite is here defined as a plastic reinforced with fibres, such as carbon fibres or glass fibres. The plastic can be a thermoplastic, thermo setting plastic or other. The structure (also called integrated monolithic structure) is thus composed of structural composite parts, defined as wing beams, shells, wing ribs, bulkheads, nose cone shell, frames, web stiffeners, etc. The structural composite parts are bonded via an adhesive film or adhesive paste onto the interior face of the aircraft shell. The adhesive can be a curing adhesive resin such as an epoxy. The adhesive film or resin or another adhesive agent applied between the structural composite parts cures before the structural composite parts cure when the structure is set in an oven or other temperature increasing exposure. That is, the adhesive resin (bonding material resin) is adapted to be curable in a temperature lower than the temperature at which the resin of the structural composite parts cures. The structural composite parts are usually separately formed (e.g. hot drape forming or mechanical forming).

The wing (aircraft structure) comprises upper and lower shells, beams, wing ribs (three-dimensional structural composite parts). A wing beam may be hollow and can be made of a stack of pre-preg plies (fibre layers impregnated with resin) and the wing ribs in a simultaneous way making another stack. The stacks are produced on a temporary support by means of e.g. an Automatic Tape Laying-machine. Each stack is thereafter moved to a respective forming tool for forming the stack into the wing beam and several wing ribs.

The finished formed wing beam is thereafter moved to an assembly and curing tool for the assembly and curing together with the other finished formed structural composite parts forming the wing and the wing shell (aerodynamic shell). The wing beam is fastened to the interior face of the shell by means of an uncured bonding thermosetting resin material having no reinforcing fibers (the uncured bonding material can be applied in the form of films (or paste or by air-brush) applied onto the structural parts' surfaces and a film (or by common alternatives) applied onto the shell face. Alternatively, only the interior face is provided with a resin film or resin paste for co-curing the aircraft structure in one cure cycle, thus achieving an aircraft structure having high strength and low weight. The settlement of the bonding non-fiber reinforcing resin (bonding material) in specific volume—created between the face and the surfaces—is performed in so called “interior face filling volumes”. Such a volume can occur due to defects or due to not exact fit between the shell and the structural part. The flow of bonding material is directed to these volumes due to less pressure (than that of surrounding areas with higher pressure during the evacuation due to the closer fitting). The flow is achieved with extreme precision due to the lack of fibers within the bonding material resin. The resin of the bonding material is not hindered to flow freely and will fill out every free volume between the face and the surfaces.

The bonding material is adapted to cure in a temperature lower than the temperature at which the first and second resin substrate of the shell and structural parts cure. Thereby the bonding material will act as a distance material generating an internal pressure against the surfaces. The whole area of the surfaces and interior face have a tendency to join together due to the vacuum set of the assembly. It provides a tendency to equalize the pressure between the surfaces and the face. For reaching the equalized pressure, the viscous uncured bonding material flows to areas having volumes that have less pressure. Such equalizing pressure functionality is achieved due to the free flow of uncured bonding resin material. Thereby a proper settlement of the bonding material is achieved between the face and surfaces during the viscous phase. In such way a predetermined measure of the assembly can be controlled and eventual defects due to poor fitting between the shell and the structural parts are eliminated. Also, the tolerance of the fit of the shell and the structural composite parts being allowed to be relatively great (i.e. their fitting tolerances have not to be close).

The uncured bonding resin material is during a first stage of the co-curing cycle allowed to flow between the shell and the structural parts before the curing of said bonding material. Since great tolerances in this way are allowed, the forming and assembly of the structural composite parts can be done effective and fast. The bonding material may (a thermo set resin is preferable) comprise a polymer material, such as polymer resins, epoxy, polyesters, vinylesters, cyanatesters, polyamids, polypropylene, BMI (bismaleimide), or thermoplastics such as PPS (poly-phenylene sulfide), PEI (polyethylene imide), PEEK (polyetheretherketone) etc., and mixtures thereof. The bonding material can also be of the same resin material group as that of pre-preg material providing the shell and structural parts (ribs, stringers, beams etc.).

Of course, also other types of structural composite parts, such as stringers, sub spars, shear-ties etc., may be assembled to an aircraft shell.

### BRIEF DESCRIPTION OF THE DRAWINGS

The present invention will now be described by way of examples with reference to the accompanying schematic drawings, of which:

FIG. 1 illustrates an aircraft comprising structural composite parts;

FIG. 2 illustrates in perspective the rudder shown in FIG. 1;

FIGS. 3a and 3b illustrate different method embodiments for producing the rudder in FIG. 1;

FIGS. 4a and 4b illustrate the distribution of the bonding material according to two further embodiments;

FIG. 5 illustrates an aircraft structure forming a tank;

FIGS. 6a to 6f illustrate a method of manufacture of an aircraft fin shown in cross-section;

FIG. 7 illustrates a shell being prepared to be infused with a first resin into before-hand prepared dry fiber mats for reinforcing the shell;

FIGS. 8a and 8b illustrate two interior face filling volumes between a shell and stringer flange shown in following FIG. 9, which volumes have been filled (shown in FIG. 8b) with bonding resin material, due to a not exact fit; and

FIG. 9 illustrates the aerodynamic shell of FIG. 8a comprising an interior step being held towards a flange of a stringer during the manufacture and the one-cure cycle.

### DETAILED DESCRIPTION

Hereinafter, embodiments of the present invention will be described in detail, wherein for the sake of clarity and understanding of the invention some details of no importance are deleted from the drawings. References having the same number may belong to one or different embodiments.

The definition of “non-structural fiber reinforced resin system” means in this application a structural resin system comprising non-structural fibers. That is, the resin system (or third uncured resin substrate) comprises no structural fibers. The resin of the resin system per se is structural.

The non-structural fiber reinforced resin system may comprise a carrier made of organic fibers having no structural property. A complementary addition of the carrier into the resin system of the bonding material provides an environment for a simple handling of the bonding material. The carrier can be included as a feature within the present invention for all embodiments or combinations thereof. The carrier being not shown in the drawings for clarity reason and therefore has no reference sign, still the carrier in such alternative embodiment would have importance for maintaining the shape of the bonding material. The organic fibers are not structural and provide no major influence on the free flow of the resin of the bonding material during the viscous phase.

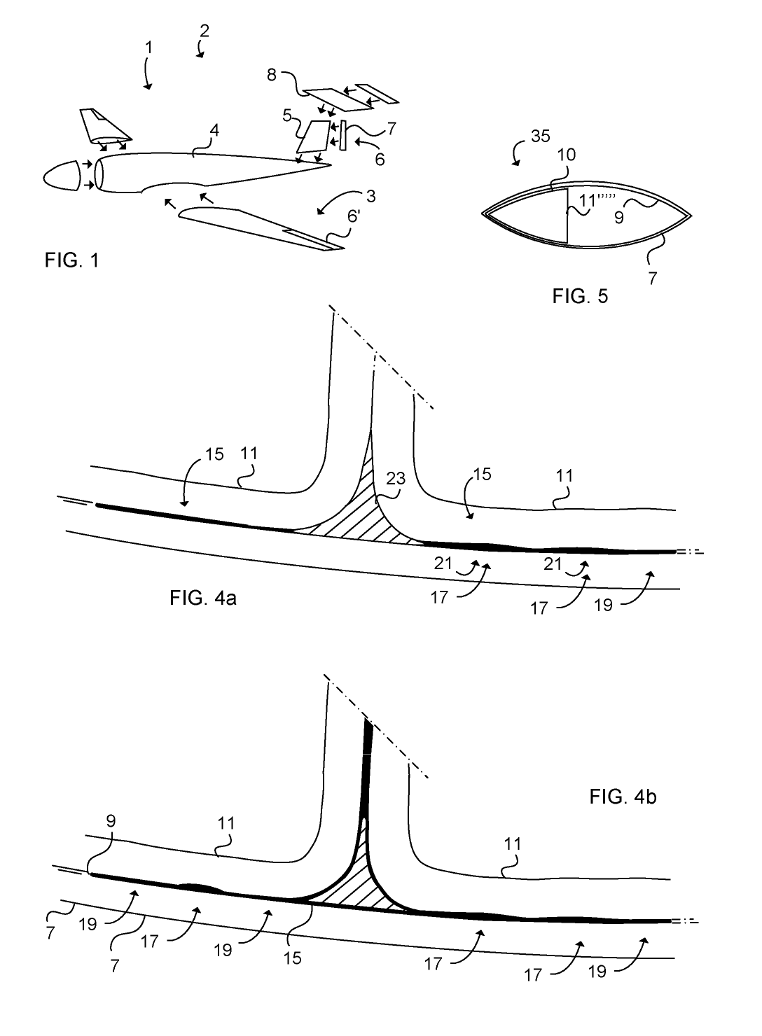

FIG. 1 illustrates in a perspective view an aircraft 1. The aircraft 1 comprises aircraft structures 2: a wing 3, a fuselage 4, a fin 5, a rudder 6, an aileron 6′, a tail plane 8 etc. The rudder 6 comprises an outer shell 7, an outer surface of which serving as an aerodynamic surface. An interior face 9 of the shell 7 is shown in FIG. 2. The rudder 6 comprises four three-dimensional structural composite parts in the form of prolonged hollow pre-preg composite beams 11′, 11″, 11′″, 11″″ of different cross-section. The shell 7 is bonded to the surfaces 10 of the beams 11. The surfaces 10 face the shell 7.

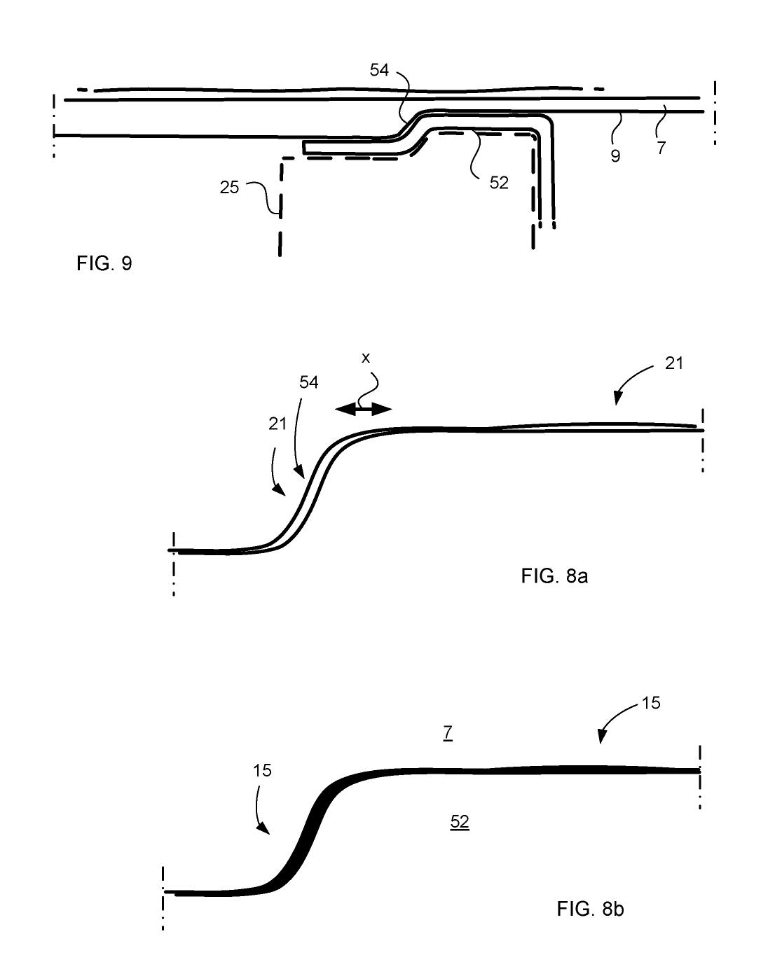

The aircraft structure 2 thus comprises the aerodynamic composite shell 7, the interior face 9 of which in whole is bonded with the four three-dimensional structural composite parts (beams 11) by means of a bonding material 15 (partly shown in FIG. 2 with cross-hatch). The bonding material 15 comprises a non-structural fiber reinforced resin system. Portions 17 (see FIG. 4b illustrating a closer view of the bonding) of the bonding material 15 are thicker than other portions 19 (see FIG. 4b) of the bonding material 15. The portions 17 spatially correspond with interior face filling volumes 21 (see FIG. 8a giving an example of such filling volume 21). The thicker portions 17 are provided due to settlement of resin of the non-structural fiber reinforced resin system into the interior face filling volumes 21 (see FIG. 8a as an example) during a viscous phase of the curing of the non-structural fiber reinforced resin system as a result of an pressure equalizing when the shell 7 and beams 11 have been joined and held together and are set under pressure within a period of time in the beginning of the cure cycle before the resin of the bonding material 15 has start to cure.

The bonding material 15 has an area of distribution extending over seven bonds joining the interior face 9 and beams 11. The area of distribution is also covering the one side of several radius fillers 23. The bonding material 15 is also considered as a fly-away tool as it is an integrated portion of the shell 7, wherein the bonding material 15 propagates parallel with the shell 7. In this embodiment the non-structural fiber reinforced resin system of the bonding material 15 is a thermo set resin.

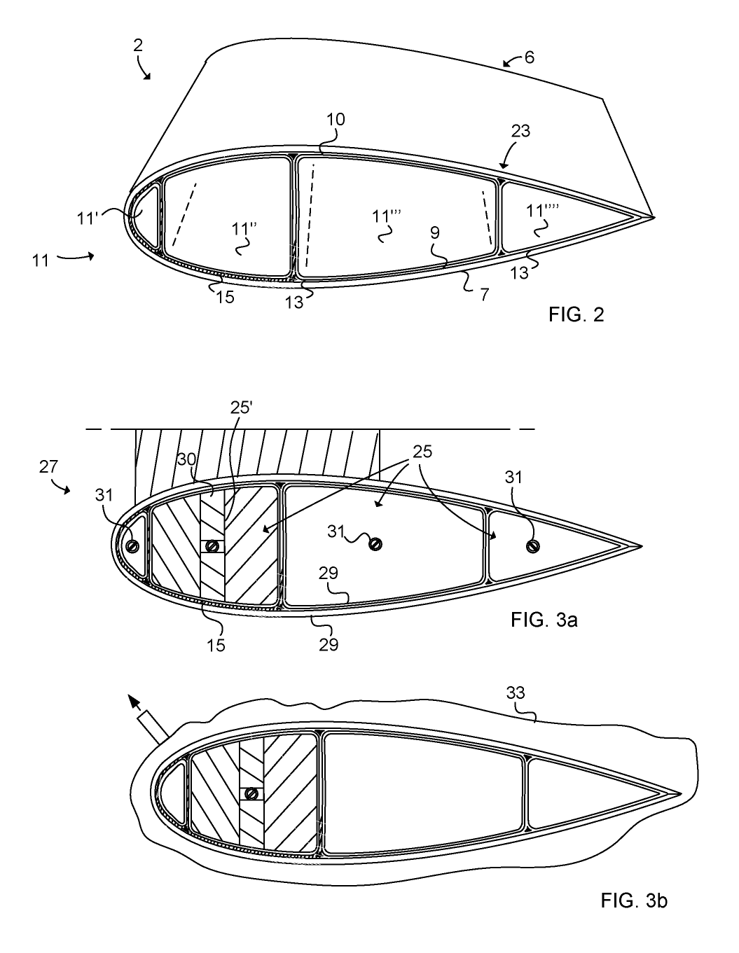

FIG. 3a illustrates a tool 25 and pre-preg assembly 27 for co-curing the pre-pregs 29 and the bonding material 15. In this embodiment the non-structural fiber reinforced resin system of the bonding material 15 (partly shown with finest line cross-hatch) comprises a pre-preg system as well but without any reinforcing fibers. For maintaining the form of the pre-preg assembly 27 partly shown tools 25 are used. Interior tools 25′ are releasable from the cured aircraft structure after curing by dismounting a wedge 30 from the tool 15 via screws 31.

FIG. 3b illustrates a method according to another embodiment for producing the rudder in FIG. 2. In this embodiment is a vacuum bag 33 used for exerting an internal pressure to the pre-pregs and bonding material. The internal pressure provides the transportation of bonding material resin into an eventual interior face filling volume 21 (see FIG. 8a as an example) during the viscous phase as will be discussed more in detail below. This embodiment has importance for maintaining the shape of the bonding material. A carrier (not shown) comprising organic fibers is added to the bonding material. The organic fibres are not structural and provide no major influence on the free flow of the resin of the bonding material during the viscous phase. They do not hinder the third resin to flow freely during the viscous phase.

FIG. 4a illustrates a discontinuous propagation of bonding material 15 otherwise propagating parallel with the aerodynamic composite shell 7. The radius filler 23 separately acts as a holding tool.

FIG. 4b illustrates the distribution of the bonding material 15 according to the embodiment described in view of FIG. 2. In this embodiment, the bonding material has an extension all over the interior surface 9 of the shell 7.

FIG. 5 illustrates an aircraft structure according to a further embodiment comprising an extra aerial tank 35. The tank 35 comprises one structural composite part formed as hollow composite cone 11′″″ and a shell 7 is formed over the cone 11′″″. Between the cone and shell is applied the bonding material 15 comprising a non-structural fiber reinforced resin system. The first (of the shell) and second resin (of the cone) have a curing temperature within the range of about 100-130° C., the third resin (of the bonding material 15) has a curing temperature within the range of about 150-180° C. The first and second resins are so called B-staged resins.

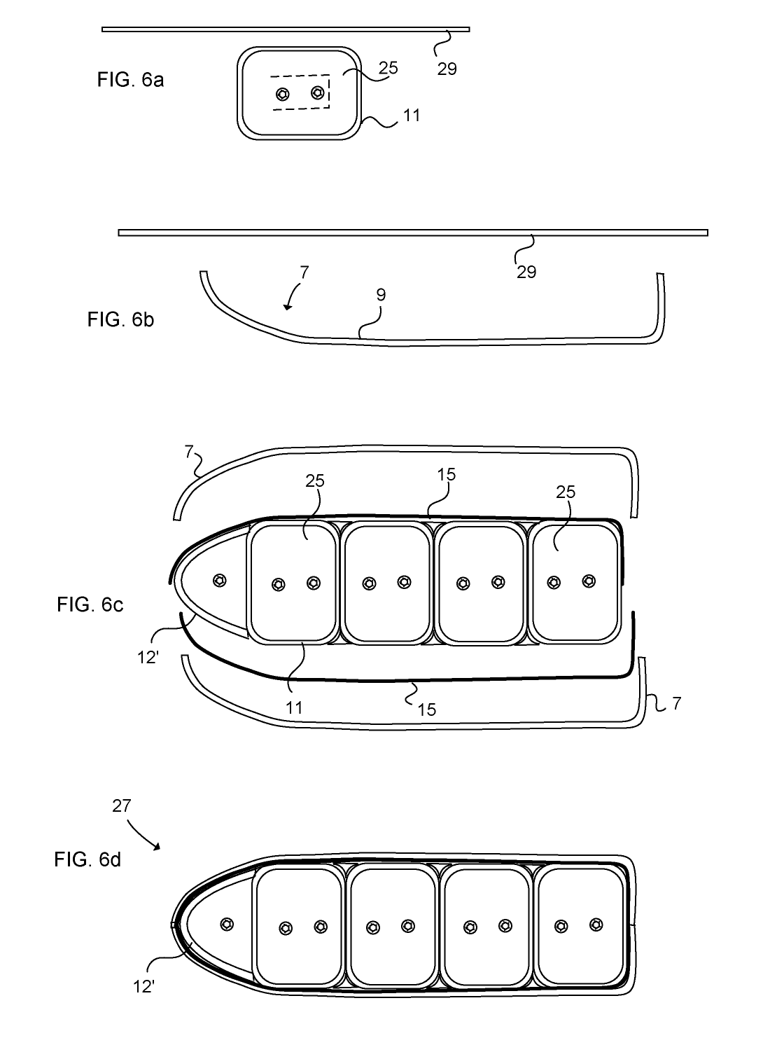

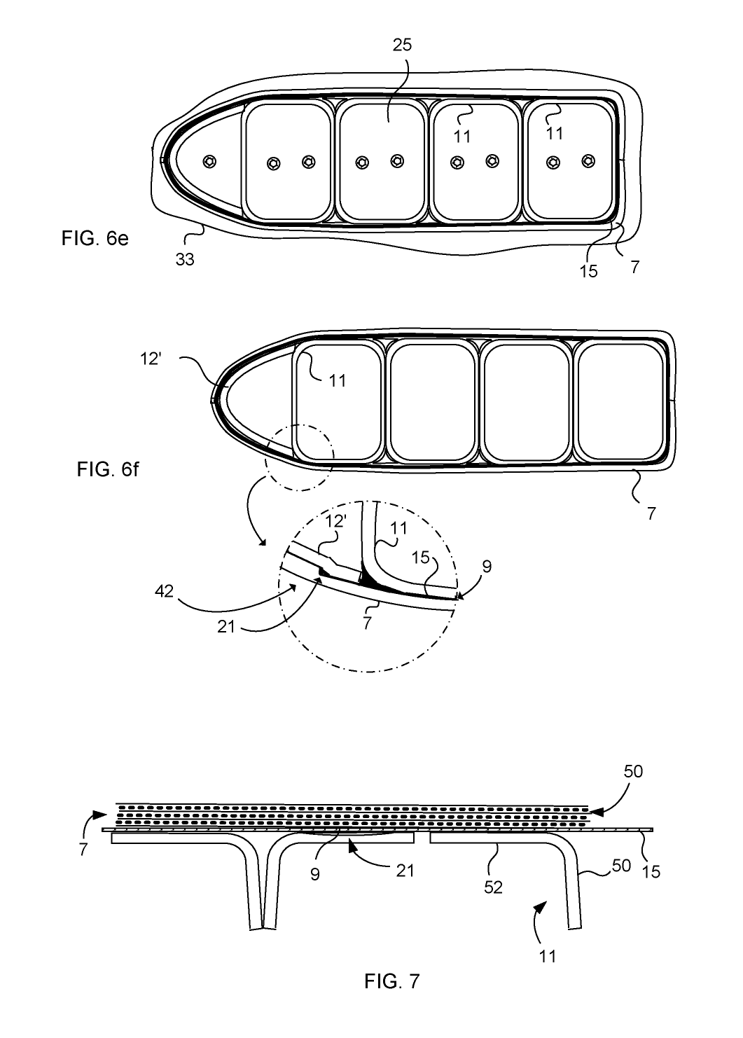

FIGS. 6a to 6f illustrate a method of manufacture of the fin 5 in FIG. 1 now shown in cross-section and more in detail. Firstly is a lay-up of pre-preg 29 tapes provided, which forms a hollow structural part 11 as shown in FIG. 6a. An interior tool 25 of steel will provide and keep the form of the part 11. Four parts 11 of this kind and a further nose part 12′ are made by such way. Another lay-up of pre-pregs is formed into a shell 7 as shown in FIG. 6b. FIG. 6c shows the assembly of the pre-pregs forming the shells 7 and the parts 11 and the bonding material 15 comprising the non-structural fiber reinforced resin system there between. Also in the assembly are tools 25 mounted. The ready assembly 27 is shown in FIG. 6d. A vacuum bag 33 is arranged around the assembly 27 of tools and pre-pregs and bonding material (FIG. 6e).

Vacuum is generated within the vacuum bag 33 and the parts 11 will adapt their curvatures more exact according to the shape of the interior tools 25.

The cure cycle takes place in an autoclave (not shown).

A first resin of the aerodynamic composite shell 7 and a second resin of each structural composite part 11 cure at a temperature higher than the temperature at which a third resin of the bonding material 15 cures.

The method thus comprises the steps of forming the first and second resin substrate into an uncured aerodynamic composite shell 7 and an uncured structural composite part 11 (FIGS. 6a and 6b), applying an uncured bonding material 15 onto the interior face 9 and/or onto the surface of the uncured structural composite part 11 facing the interior face 9, applying the uncured structural composite part 11 to the interior face 9 of the uncured aerodynamic shell 7 with the bonding material there between (FIG. 6c).

The cure cycle starts and temperature rise from room temperature up to at highest 150° C. The third resin substrate (bonding material resin) has a curing temperature within the range of about 90-100° C. and the first and second resin substrate curing temperature within the range of about 130-140° C. Thereby the viscous phase of the third resin will occur before the occurrence of the viscous phase of the first and second resin substrate.

The viscous third resin will thus freely flows from areas under the shell 7 (see FIG. 6f), where high pressure prevails, to areas under the shell, where low pressure prevails. This unhindered flowing of the third resin is provided by the lack of fibres within the third resin. This safe and unhindered flow of the third resin makes the production efficient.

This integrally co-curing of the first resin, the second resin, the third resin in one cure cycle,—in such way that the third resin during the viscous phase freely flows into an interior face filling volume 21 (also see FIG. 8a as another example) defined between the interior face 9 and part 11 surface—, makes sure that the bonding material 15 fills eventual defects or voids or displacement of the fitting between the shell 7 and the parts 11 and thereafter cures (at a temperature of 90-100° C.) in an efficient way. The bonding material 15 now constitutes a fly-away tool. The following temperature increase thus has provided a curing of the third resin before curing of the first and second resin. A so called fly-away tool has thus been provided (at the same time as it will act as a bonding between the shell 7 and the parts 11). Following, the temperature proceeds to rise (in the same cure cycle) and the shell 7 and parts 11 will more easy form their curvatures to each other and bond together via an exact distributed bonding material 15. The bonding occurs when the shell 7 and parts 11 cure as well, but at a temperature of 130-140° C.

In FIG. 6f is shown that the tools are removed after curing and the fin 5 is finished (at least structurally). A stepped portion 42 of the interior face 9 of the shell 7 is shown with an enlargement within a broken circle in FIG. 6f. The nose part's 12′ surface facing the shell face 9 has difficulties to reach the shell face within this stepped portion. There will be an interior face filling volume 21 within the stepped portion 42 between the shell and the part 12′. The third resin (bonding material resin) is thus during the viscous phase (in the one co-cure cycle) provided for freely flowing towards the interior face filling volume 21, having a lower pressure than the other areas (adjacent face 9 of shell 7 to surface of part 12′) surrounding the interior face filling volume. The settlement of the third resin (bonding material resin), over this stepped portion in contact with the part 12′, builds up a thicker bonding material 15 which cures before the first and second resins cure. That means a thicker thickness of bonding material in volume 21 than in the surrounding areas of the bonding material 15. In such way no voids are present in the region of the stepped portion 42.

FIG. 7 illustrates a shell 7 being prepared to be infused with a first resin into before-hand prepared dry fiber mats 50 applied onto each other in a stack. The structural parts 11 (stringers) having flanges 52 that are facing the shell 7. A bonding material 15 in the form of infused uncured bonding resin free from fibers is interlayer between the shell 7 and parts 11. The first and second resins are formed into the uncured aerodynamic composite shell 7 and an uncured structural composite part 11. They comprise resins that are suitable for liquid composite moulding, wherein the first and second resins are infused into before-hand prepared dry fiber mats 50. The non-structural fiber reinforced resin system of the bonding material 15 is positioned between the dry fiber mats 50 of the shell and the dry fiber mats 50 of the structural parts. The resins are preferably thermo set after cure procedure. The first and second resin have a curing temperature within the range of about 120-140° C., the third resin has a curing temperature within the range of about 60-80° C. An elongated void is defined as a defect and as an interior face filling volume 21 adjacent the shell face 9.

The volume 12 will be filled after the cure cycle and the shell 7 will maintain its predetermined shape.

FIG. 8a illustrates a closer view of that in FIG. 9 illustrated step-formed interior face 9. An interior step 54 is formed in the shell 7. It has been critical to form the stringer flange 52 held by tool 25 for filling the interior face volume within the area of the step and between the flange 52 and shell 7 with the flange material. It is also critical with a step of described art since the fitting is sensitive for displacement in direction x. A small defect making a displacement in direction x creates a volume 21. In FIG. 8b is shown the cured bonding material having the unique performance as a fly-away tool.

Although particular embodiments have been disclosed herein in detail, this has been done for purposes of illustration only, and is not intended to be limiting with respect to the scope of the appended claims. The embodiments can also be combined. In particular, it is contemplated by the applicant that various substitutions, alterations, and modifications can be made to the invention without departing from the spirit and scope of the invention as defined by the claims. For instance, also two-dimensional structural composite part can be bonded to the interior face, such as interior planar composite plates etc. For instance, the structural part can be a rib, beam, stringer, spar cap etc.

1-14. (canceled)

15. An aircraft structure comprising an aerodynamic composite shell (7), the interior face (9) of which in whole or in part is bonded with at least one two- or three-dimensional structural composite part (11) via a bonding material (15), wherein the bonding material (15) is a wide spread layer having various thickness and within the range of about at least 50 cm² to 50 m², comprising a structural resin system not having structural fibers; and wherein at least one portion of the bonding material, which portion spatially corresponds with an interior face filling volume (21), is thicker than other portions of the bonding material (15) due to settlement of resin of the structural resin system not having structural fibers in said interior face filling volume (21) during the viscous phase of the curing of the structural resin system not having structural fibers.

16. An aircraft structure according to claim 15, wherein the structural resin system not having structural fibers comprises a carrier.

17. An aircraft structure according to claim 15, wherein the structural resin system not having structural fibers is a thermo set resin.

18. An aircraft structure according to claim 15, wherein the bonding material (15) has an area of distribution extending over two or more bonds joining the interior face (9) and structural composite parts (11).

19. An aircraft structure according to claim 15, wherein the bonding material (15) is considered as a fly-away tool as it is an integrated portion of the aerodynamic shell (7).

20. An aircraft structure according to claim 15, wherein the bonding material (15) propagates parallel with the aerodynamic composite shell (7).

21. An aircraft structure according to claim 15, wherein the aircraft structure is an aileron (6′).

22. A method of manufacturing an aircraft structure (2) comprising an aerodynamic composite shell (7), the interior face (9) of which in whole or in part is bonded with at least one two- or three-dimensional structural composite part (11) via a bonding material (15) that is a wide spread layer having various thickness and within the range of about at least 50 cm² to 50 m² in the form of a structural resin system not having structural fibers, a first resin substrate of the aerodynamic composite shell (7) and a second resin substrate of the structural composite part (11) cure at a temperature higher than the temperature at which a third resin substrate of the bonding material (15) cures, the method comprising the steps of:
forming the first and second resin substrate into an uncured aerodynamic composite shell (7) and an uncured structural composite part (11);
applying an uncured bonding material (15) onto at least one of the interior face (9) or the surface (10) of the uncured structural composite part (11) facing the interior face (9);
applying the uncured structural composite part (11) to the interior face (9) of the uncured aerodynamic shell (7); and
integrally co-curing the first resin substrate, the second resin substrate, the third resin substrate in one cure cycle, in such way that the third resin during the viscous phase freely flows into an interior face filling volume (21) defined between the interior face (9) and part surface (10), and following temperature increase provides curing of the third resin before curing of the first and second resin substrates.

23. A method of manufacturing an aircraft structure according to claim 22, wherein the third resin during the viscous phase is provided for freely flowing towards an interior face filling volume (21) having a lower pressure than the other areas surrounding the interior face filling volume (21), wherein settlement of the third resin substrate building up a thicker bonding material which cures before the first and second resin substrates.

24. A method of manufacturing an aircraft structure according to claim 22, wherein the bonding material (15) has an area of distribution extending over two or more bonds joining the interior face (9) and structural composite parts (11).

25. A method of manufacturing an aircraft structure according to claim 22, wherein the first and second resin substrates are B-staged resins.

26. A method of manufacturing an aircraft structure according to claim 22, wherein the third resin has a curing temperature within the range of about 100° C.-130° C., and wherein the first and second resin substrates have a curing temperature within the range of about 150° C.-180° C.

27. A method of manufacturing an aircraft structure according to claim 22, wherein the third resin has a curing temperature within the range of about 40° C.-90° C., and wherein the first and second resin substrates have a curing temperature within the range of about 80° C.-130° C.

28. A method of manufacturing an aircraft structure according to claim 27, wherein the third resin has a curing temperature within the range of about 50° C.-80° C., and wherein the first and second resin substrates have a curing temperature within the range of about 90° C.-120° C.

29. A method of manufacturing an aircraft structure according to claim 22, wherein the cure cycle takes place in an autoclave.

30. A method of manufacturing an aircraft structure according to claim 22, wherein the cure cycle takes place out of an autoclave.
